(19) United States
(12) Patent Application Publication
(10) Pub. No.: US 2009/0029080 A1
(43) Pub. Date: Jan. 29, 2009

(54) Multilayer biaxially coriented film or tube

(76) Inventors: Donna Lynn Visioli, Lower Gwynedd, PA (US); Heiko E. Schenck, Eppstein (DE)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/217,165

(22) Filed: Jul. 2, 2008

Related U.S. Application Data
(60) Provisional application No. 60/961,883, filed on Jul. 24, 2007.

(51) Int. Cl. B32B 27/36; B29C 47/78; B29D 7/01; B32B 1/00; B29C 55/16

(52) U.S. Cl. 428/34.8; 428/34.9; 264/210.1; 428/343; 428/480

(57) ABSTRACT

A process for preparing a multilayer biaxially oriented polyester film is provided wherein at least one layer comprises a blend of a poly(trimethylene terephthalate) resin and an additional polyester resin. Such films are particularly adapted for use in manufacture of packaging films.

### CROSS REFERENCE TO RELATED APPLICATION

This application claims the benefit of U.S. Provisional Application No. 60/961,883, filed Jul. 24, 2007, the entire contents being incorporated herein by reference.

### FIELD OF THE INVENTION

This invention relates to methods for making biaxially oriented multilayer films prepared from poly(trimethylene terephthalate) that are particularly useful in packaging applications.

### BACKGROUND OF THE INVENTION

Poly(trimethylene terephthalate) is useful in many materials and products in which polyesters are currently used, for example films, containers and packaging. British Patent 578,097 discloses the synthesis of poly(trimethylene terephthalate). The polymer itself is commercially available from E. I. du Pont de Nemours and Company (DuPont) under the tradename SORONA.

Biaxially oriented films and film laminates are used commercially on a large scale in shrink packaging of food items. The advantage of incorporating polyesters in shrink film structures is that polyesters are dimensionally stable at high humidity. The use of poly(trimethylene terephthalate) has been proposed in various heat shrinkable film laminates. For example, Japanese patent application H11-105222 discloses heat-shrinkable multilayer films having poly(trimethylene terephthalate) outer layers. Japanese patent application H11-115129 discloses multilayer shrink films with poly(trimethylene terephthalate) inner layers. Japanese patent application H11-246684 discloses heat shrinkable polyester films prepared from blends of poly(trimethylene terephthalate) and polyethylene terephthalate.

However, a need still exists for multilayer films, including shrink films, that incorporate polyester and have improved toughness.

### SUMMARY OF THE INVENTION

The invention provides a process for preparing a heat shrinkable multilayer biaxially oriented film wherein at least one layer comprises a poly(trimethylene terephthalate) resin blend composition, the process comprising:
(a) extruding a polymer melt, the polymer melt comprising a blend of a poly(trimethylene terephthalate) resin and an additional polyester resin, through a die;
(b) allowing the extruded polymer melt to solidify on the surface of a substrate comprising at least one additional thermoplastic polymer layer to form a primary film having a degree of crystallinity required for subsequent processing while controlling the temperature and thickness of the primary film;
(c) simultaneously biaxially orienting the primary film at an orientation temperature in two mutually perpendicular directions in the plane of the primary film to form a biaxially oriented film; and
(d) cooling the biaxially oriented film to a temperature below the orientation temperature.

The invention is also directed to articles comprising the film prepared by the above process, such as sausage casings and shrinkbags for food products such as meats.

The invention also provides a process for preparing a dimensionally stable multilayer biaxially oriented film, at least one layer comprising a poly(trimethylene terephthalate) resin blend composition, the process comprising:
(a) extruding a polymer melt, the polymer melt comprising a blend of a poly(trimethylene terephthalate) resin and an additional polyester resin, through a die;
(b) allowing the extruded polymer melt to solidify on the surface of a substrate comprising at least one additional thermoplastic polymer layer to form a primary film having a degree of crystallinity required for subsequent processing while controlling the temperature and thickness of the primary film;
(c) simultaneously biaxially orienting the primary film in two mutually perpendicular directions in the plane of the primary film to form a biaxially oriented film;
(d) heat setting the biaxially oriented film at a heat set temperature; and
(e) cooling the biaxially oriented firm to a temperature below that of the heat set temperature,
thereby obtaining a dimensionally stable biaxially oriented film.

### DETAILED DESCRIPTION

The process of the present invention is directed to formation of certain multilayer oriented polyester films and to products made from such films.

In one embodiment the present invention is directed to multilayer oriented films that are capable of shrinking to a substantial extent when exposed to temperatures of at least 85° C. for a period of at least two minutes. By a substantial extent is meant a reduction in size of 25% or more. These films are members of the class of films conventionally known as “shrink films” or “shrink wraps”. Such films find utility in manufacture of “shrinkbags”. A second embodiment of the invention is directed to a process for the production of dimensionally stable multilayer oriented films.

Films of the first embodiment are multilayer oriented shrink films that undergo a stretching operation during manufacture. The films are not heat-set during the manufacturing process. The films are therefore capable of changing dimension by shrinking to close to their unstretched size or dimension on their first, i.e. initial, exposure to temperatures higher than the temperature of their orientation. Shrinkage of such films does not occur to any great extent on subsequent exposures to a temperature above the orientation temperature.

The multilayer heat shrinkable films of the invention are generally in the form of flat sheets or in tubular form. They are oriented structures, preferably of thickness 275 microns or less, that are capable of shrinking in size by an amount of 25% or more from their original oriented dimensions on initial exposure to a temperature of 85° C. for a time of at least one minute. Preferably the films are capable of shrinking in size by an amount of 35% or more from their original oriented dimensions when exposed to a temperature of 95° C. for a time of at least one minute. It is not unusual for applications for shrink bags to require from about 40% to about 50% shrinkage from the original dimensions.

Shrink properties are measured by placing 4×4 inch (i.e. 101 mm×101 mm) squares of film, with the machine direction (MD) and transverse direction (TD) of the films marked, into a waterbath maintained for example at 85° C. for 2 minutes, and then measuring the dimensions of the treated films. The % shrinkage is calculated as the absolute value obtained from the formula [(L₁−L₀)/L₀]×100, where L, is the dimension in the machine or transverse directions after shrink, and Lo is the dimension in the machine or transverse directions of the original film.

The multilayer polyester films of the present invention comprise at least one layer of a poly(trimethylene terephthalate) resin blend composition. Poly(trimethylene terephthalate) resin is a polyester resin prepared by the condensation polymerization of 1,3-propanediol and terephthalic acid. Poly(trimethylene terephthalate) may also be prepared from 1,3-propanediol and dimethylterephthalate (DMT) in a two-vessel process using tetraisopropyl titanate catalyst, TYZOR TPT, available from DuPont. Molten DMT is added to 1,3-propanediol and catalyst at about 185° C. in a transesterification vessel, and the temperature is increased to 210° C. while methanol is removed. The resulting intermediate is transferred to a polycondensation vessel where the pressure is reduced to one millibar (10.2 kg/cm²) and the temperature is increased to 255° C. When the desired melt viscosity is reached, the pressure is increased and the polymer may be extruded, cooled and cut into pellets.

The poly(trimethylene terephthalate) resin, referred to herein as 3GT, may be a 3GT homopolymer by which term is meant a polymer that is prepared by polymerization of 1,3-propanediol with terephthalic acid, or alternatively, a polymer that is the product of reactants which can be polymerized to provide a polymer of poly(trimethylene terephthalate). One example of a resin that is a product of reactants that can be polymerized to provide a polymer of poly(trimethylene terephthalate) is the resin prepared by reaction of 1,3-propanediol with a diester of terephthalic acid.

The poly(trimethylene terephthalate) resin may also be a 3GT copolymer by which term is meant a polymer that comprises at least 80 mol % poly(trimethylene terephthalate) and additionally comprises other copolymerized monomer units. The copolymer may comprise, for example up to 20 mol % copolymerized units of diols other than 1,3-propanediol or diacids other than terephthalic acid.

Other diacids that are useful comonomers of 3GT copolymers include isophthalic acid, 2,6-naphthalenedicarboxylic acid, 1,4-cyclohexane-dicarboxylic acid, 1,3-cyclohexanedicarboxylic acid, succinic acid, glutaric acid, adipic acid, sebacic acid, 1,12-dodecanedioic acid, and the derivatives thereof, such as the dimethyl, diethyl, or dipropyl esters of these dicarboxylic acids.

Other diols that may be present as copolymerized monomers include ethylene glycol, 1,4-butanediol, 1,2-propanediol, diethylene glycol, triethylene glycol, 1,3-butanediol, 1,5-pentanediol, 1,6-hexanediol, 1,2-, 1,3- and 1,4-cyclohexanedimethanol, as well as the longer chain diols and polyols prepared by the reaction of diols or polyols with alkylene oxides.

Small amounts of a chain-branching agent such as pentaerythritol, trimethylolpropane, trimellitic acid, trimesic acid or boric acid may also be used as comonomers.

Of note is a 3GT copolymer comprising poly(trimethylene terephthalate) and one or more comonomers selected from the group consisting of ethylene glycol, 1,4-cyclohexanedimethanol, terephthalic acid, and isophthalic acid. Also of note is the 3GT copolymer that further comprises a chain-branching agent as a comonomer.

The 3GT homopolymer or copolymer resin compositions useful in the practice of the invention are blended with at least one other thermoplastic polyester resin. At least 1 weight percent, preferably at least 10 weight percent, of the 3GT polyester resin will be present in the polyester blend composition. For example, the 3GT polyester may be blended with up to 90 weight percent, based on the total amount of polyester resins present, of at least one polyester prepared from diols other than 1,3-propanediol or diacids other than terephthalic acid. Thus, compositions comprising 10 weight percent 3GT polyester resins and 90 weight percent of another polyester are within the scope of polyester resins useful in the process of the present invention. One group of useful compositions includes blends of polyesters wherein the polyester other than 3GT is present in an amount of at least 40 weight percent. Examples of useful polyesters other than 3GT include polyethylene terephthalate, polytetramethylene terephthalate, polycyclohexane-dimethylene terephthalate and polyethylene-2,6-naphthalene dicarboxylate. The polyesters that are blended may also be copolymers that comprise copolymerized units of either additional alcohols and/or additional dicarboxylic acids. A portion of the dicarboxylic acid comonomers may be, for example, isophthalic acid, 2,6-naphthalenedicarboxylic acid, 1,4-cyclohexanedicarboxylic acid, adipic acid, sebacic acid, dimer acid, and isophthalic acid containing a metal salt of sulfonic acid as a substituent, such as 5-sodium sulfoisophthalate, for example. The diols may include diethylene glycol, neopentyl glycol, 1,4-cyclohexanediol, 1,4-cyclohexanedimethanol, polyalkylene glycol, 1,2-propanediol and 1,4-butanediol, for example. Small amounts of a chain-branching agent such as pentaerythritol, trimethylolpropane, trimellitic acid, trimesic acid or boric acid may also be used as comonomers. The most preferred polyesters to be blended with the 3GT homopolymers or 3GT copolymers are poly(ethylene terephthalate) homopolymer or poly(ethylene terephthalate) copolymers. Of note is a poly(ethylene terephthalate) homopolymer available as MERGE 3934 from DuPont.

Other ingredients may be added to the 3GT homopolymer or copolymer resin blend compositions to enhance performance characteristics. For example, crystallization aids, impact modifiers, surface lubricants, denesting agents, stabilizers, antioxidants, ultraviolet light absorbing agents, metal deactivators, colorants such as titanium dioxide, carbon black, dyes, and pigments, phosphate stabilizers, fillers, antistatic agents, flame retardants, auxiliary flame retardants, lubricants, plasticizers and the like may be added alone or in combination. Generally, such additives will be present in amounts of up to 15 weight percent based on the total weight of the resin composition. Of course, these additives should not be employed in amounts that would adversely affect the benefits achieved by the present invention.

The films prepared by the process of the invention, whether shrink films or dimensionally stable films, are multilayer films comprising 3GT homopolymer or 3GT copolymer resins.

In general terms, in a first embodiment of the process of the invention wherein a shrink film is produced, the process will comprise the steps of extruding a flow of a molten polymeric resin blend composition, i.e. a polymer melt, solidifying (quenching) the extruded polymer melt on a substrate comprising at least one additional thermoplastic polymer layer to form a primary film, and then simultaneously orienting or drawing the primary film in two mutually perpendicular directions (biaxially orienting) in the plane of the film at an orientation temperature and then cooling the biaxially orientated film to a temperature below the orientation temperature to achieve a satisfactory combination of mechanical and physical properties.

The multilayer primary film structures of the invention are formed by laminating a molten polyester blend extrudate (a blend of a poly(trimethylene terephthalate) resin and an additional polyester resin) by contacting the extrudate to additional thermoplastic polymer layer material, preferably by coextrusion, extrusion coating, or extrusion lamination. The lamination involves the steps of extrusion and quenching to solidify the molten extrudates. Other thermoplastic layers include for example, polyethylene, including linear low density polyethylenes made by any process, including metallocene, constrained geometry, Versipol® or Ziegler-Natta processes, ethylene copolymers such as ethylene alkyl acrylate copolymers, ethylene alkyl methacrylate copolymers, polypropylene, polyamide, ethylene acrylic acid copolymer and ionomers, ethylene methacrylic acid copolymers and ionomers, ethylene vinyl alcohol, ethylene vinyl acetate copolymers and other thermoplastic polymers generally used in packaging applications known to those skilled in the art. In addition, one or more adhesive tie layers may be present as optional layers. The composition of such tie layers is generally based on polymeric components including ethylene copolymers, maleic anhydride graft copolymers, polyethylene and other polymeric components well known to those skilled in the art. The purpose of the tie layer or layers is to bond the polyester layer to another layer of different composition.

In the extrusion step a poly(trimethylene terephthalate) resin blend composition is extruded through one or more dies, for example slot dies, to form a molten extrudate. The molten extrudate may be a monolayer or multilayer polyester resin blend extrudate. The molten extrudate is combined with at least one additional thermoplastic polymer layer. The quenching procedure is performed simultaneously with or subsequent to combination of the molten extrudate with the additional thermoplastic layer or layers.

Cast extrusion or blown film extrusion are examples of methods for forming a multilayer primary film of the invention by coextrusion. In these methods, granulates of the various layer components (at least one of which is the poly(trimethylene terephthalate) resin composition blended with another polyester), are melted in suitable extruders. The molten polymers are passed through a set of dies, e.g. slot dies or annular (circular) dies to form layers of molten polymers that are processed as layered flows. In cast extrusion techniques, the melt is processed through a slot die to form a flat film or sheet. In blown film coextrusion an annular die will be used and the multilayer extrudate will be in the form of a tube.

Quenching the cast film or blown film extrudates involves cooling the extrudates below their melting temperatures to form a primary film. In either process the extrudate is cooled rapidly to form a primary film wherein the poly(trimethylene terephthalate) resin blend composition component is amorphous or noncrystalline. In cast film coextrusion, the molten poly(trimethylene terephthalate) resin blend composition is quenched between a set of nip rolls spaced apart to form the molten flow into a primary film of the desired thickness. The nip rolls may be cooled with, for example, chilled water. In blown film coextrusion, the molten flow is quenched by cooling in air to form a tubular primary film, which may be further quenched on a quench drum. Temperature may be controlled by adjustment of the temperature of the quenching drum, adjustment of cooling air or the nip rolls.

A multilayer primary film or the invention may also be prepared by extrusion of the poly(trimethylene terephthalate) resin blend composition followed by lamination of the composition onto one or more other layers. In extrusion coating, a curtain of the molten poly(trimethylene terephthalate) resin blend composition is coated onto a film substrate comprising one or more layers of thermoplastic material. In the resulting multilayer structure, the poly(trimethylene terephthalate) resin blend composition forms an outer layer. In extrusion lamination, the curtain of the molten poly(trimethylene terephthalate) resin blend composition is coated onto a first film substrate comprising one or more layers and a second film substrate comprising one or more layers is applied over the poly(trimethylene terephthalate) resin blend composition while it is still molten. In the resulting multilayer structure, the poly(trimethylene terephthalate) resin blend composition is an inner layer. In extrusion coating or extrusion lamination, quenching is carried out using nip rolls.

These illustrative methods provide a primary film comprising the poly(trimethylene terephthalate) resin blend composition. Temperature may be controlled by adjustment of the temperature of the quenching drum, adjustment of cooling air or the nip rolls.

In the quenching step the conditions under which the extruded polymer melt is solidified to form a primary film can be selected to provide the desired degree of crystallinity required for subsequent processing. At the same time the temperature and thickness of the primary film are controlled.

The thickness of the primary film may be determined by factors such as the extruder speed, the die gap, the separation of the nip rolls or other appropriate adjustments known to those skilled in the art. Although the thickness of the primary film is arbitrary and dependent on its application, it is preferably from about 10 μm to about 3000 μm, and in particular, from about 20 μm to about 1000 μm, for example. As can be appreciated, once the primary film is stretched in an orientation step, its thickness will be reduced by an amount that is proportional to the amount of stretching.

The heat shrinkable films of the invention are further oriented beyond the orientation that is provided by the immediate quenching or casting of the primary film to provide improved properties and shrinkability. The temperature selected for orienting a film, i.e the orientation temperature, can depend on many factors, including the compositional type and number of film layers being oriented, the melt indices of the components of the film, the stretching forces applied to the film during the orientation process, the speed of the film production line, and/or the degree of stretching desired. The invention is not limited to any temperature or temperature range; however many conventional orientation processes can be conducted within a range of from about 50° C. to about 125° C. Any individual temperature within this range can be useful in orienting a film for use in shrink applications, depending on at least some of the factors listed herein. Many preferred orientation processes are carried out within a temperature range of from about 80° C. to about 100° C.

Biaxial drawing or orientation may be performed in successive steps, i.e. in a sequential orientation process, by first longitudinally drawing the primary film and then laterally drawing the film or vice versa. A disadvantage of successive biaxial drawing is that the second drawing step, either lateral or longitudinal, results in a partial destruction of the effects of the first drawing step; and, accordingly, when a film is subjected to successive biaxial drawing treatments, it is necessary to take remedial steps to restore the effects of the first drawing. However, in certain circumstances, such films are still suitable as shrink films.

In order to avoid the disadvantages of successive biaxial drawing, simultaneous biaxial orientation is used, that is, drawing in both longitudinal and lateral directions at the same time.

Orientation and stretching apparatus for biaxially stretching films is known in the art and may be adapted by those skilled in the art to produce the films. Examples of such apparatus and processes include e.g. those disclosed in U.S. Pat. Nos. 3,278,663; 3,337,665; 3,456,044; 4,590,106; 4,760,116; 4,769,421; 4,797,235 and 4,886,634.

Orientation of multilayer films is generally carried out on a commercial scale using double bubble tubular or tenterframe processes conducted at the orientation temperature of the film.

In one embodiment, the film is oriented through a double bubble extrusion process, where simultaneous biaxial orientation may be effected by extruding a primary multilayer film tube which is subsequently quenched, reheated and then expanded by internal gas pressure to induce transverse orientation, and drawn by differential speed nip or conveying rollers at a rate which will induce longitudinal orientation. More particularly, a primary tube is melt extruded from an annular die. This extruded primary tube is cooled quickly to minimize crystallization and then collapsed. It is then again heated to its orientation temperature (e.g. by means of a water bath). In the orientation zone a secondary tube is formed by inflation, thereby radially expanding the film in the transverse direction, and the tube is pulled or stretched in the machine direction at a temperature such that expansion occurs in both directions, preferably simultaneously; the expansion of the tubing being accompanied by a sharp, sudden reduction of thickness at the draw point. The tubular film can then again be flattened through nip rolls. Flat films can be prepared by splitting the tubular film along its length and opened up into flat sheets that can be rolled and/or further processed. This technique may have the disadvantage of providing non-uniform films of irregular thickness.

Machine manufacturers employing the double bubble tubular process technology include Kuhne Anlagenbau, Macro Engineering & Technology, and Plamex Maschinenbau. Preferably, the film can be processed on the manufacturing machine at a speed higher than 50 meters per minute (m/min), and up to a speed of 200 m/min. The film is therefore compatible with high-speed machines.

In order to simultaneously draw a flat plastic film in both longitudinal and lateral directions, the film may be provided with reinforced edges, and the film may be longitudinally drawn by two groups of rollers driven at different speeds while lateral drawing is accomplished by a plurality of clamps gripping the edges of the films and slidably movable in spaced guides, the guides being oriented to increase the spaces between them in the area between the two groups of rollers.

In a preferred embodiment, the film is oriented using a tenterframe process. In this method, the film is drawn in the machine direction (MD) by propelling tenter clips, which grip the film, in pairs along opposed tracks at ever increasing velocities to space the pairs of clips from each other and thereby draw the film longitudinally. Transverse direction (TD) drawing occurs as the clips follow diverging portions of the tracks.

Typical methods for drawing film in this manner are disclosed in U.S. Pat. No. 3,890,421; in Japanese patent publication 48-38779; and in French Patent 2,317,076.

Linear-motor-driven transport installations, in particular stretching installations, are disclosed, for example, by U.S. Pat. No. 5,072,493, DE 29 30 534 A1, DE 195 10 281 C1 and U.S. Pat. No. 5,036,262 or U.S. Pat. No. 4,853,602. These may involve synchronous, asynchronous or hysteresis motor-operated linear drives.

In such cases the circulating tenter clip carriages are accelerated with increasing intensity from a running-in speed in the running-in zone in the following stretching zone, their distance from one another increasing. In a customary subsequent relaxation or setting zone, the speed of the tenter clips is reduced slightly with respect to the speed at the end of the stretching zone.

In the subsequent deflecting zone, and in particular on the return side, the tenter clip carriages are again braked with increasing intensity down to the speed in the running-in zone. In the case of such transport installations the total number of tenter clips is prescribed and can be changed only when the installation is at a standstill and, moreover, the number of tenter clips on the process and film side is already prescribed by the prescribed process conditions (namely the longitudinal stretching ratio), the difference from the total number of tenter clips on the return side of the installation (after the tenter clips have released the edge of the film) must be set and changed on this basis, according to the installation conditions. To be able in this case to accommodate any number of tenter clips on the return side, the average distance between the tenter clips must be variable, this distance being defined by the speed profile, as is described in U.S. Pat. No. 4,825,111.

In the apparatus of U.S. Pat. No. 4,825,111, each tenter clip on the return side runs through three regions. In the first region, the tenter clips travel at constant speed, which corresponds to the final film speed. Thereafter, the tenter clip carriages are decelerated in one or more stages. In the third region, the tenter-clip carriages again travel at constant speed, which is equal to the running-in speed. To set the average distances between the tenter-clip carriages appropriately on the return side, the limits between the regions are shifted. For this purpose, corresponding motors, which are capable of braking the tenter clips and/or continuing to maintain the transport of the tenter clips, are provided over the entire length of the return. The tenter clips may be driven by linear motors.

An improved tenter clip return section, divided into a speed changing zone, a following transporting zone and a subsequent braking zone, is disclosed in U.S. Pat. No. 6,043,571. The length of the speed-changing zone and the braking zone is together less than 40% of the overall length of the return section. In the speed-changing zone and/or braking zone more powerful drive devices are provided than in the other part of the return section, in order to subject the carriages there to a more intense change in speed.

Machine manufacturers employing the tenterframe technology include Bruckner.

The biaxially oriented multilayer film may optionally be irradiated by processes known in the art. This may be accomplished by irradiation prior, during or subsequent to orientation. For example, irradiation dosage may be from about 1 mRad to about 10 mRad, or from 2 to 5 mRad. Stretchability, heat resistance and mechanical strength can be improved with irradiation. Usually irradiation reduces stretchability.

In another embodiment of the process of the invention, the biaxially oriented multilayer film may be heat set after orientation to provide dimensionally stable biaxially oriented multilayer films, in contrast to shrink films of the above-described embodiment. The extrusion, solidification of the melt to form a primary film (quenching), biaxial orientation and cooling steps of the process are conducted in the same manner as described above for formation of a multilayer shrink film. Heat setting (annealing) after orientation provides for good dimensional stability when the film is reheated to a temperature above its orientation temperature.

Heat setting can be accomplished by holding the biaxially oriented film under slight tension while heating until the composition can crystallize and fix the oriented polymeric chains within the composition. The heat set temperature is preferably the temperature of fastest crystallization rate, which is usually between melt temperature and the glass transition temperature Tg. Tg may be measured by using a differential scanning calorimeter (DSC) per ASTM D-3417 at a heating rate of 10° C./min for heating and cooling, and the mid-point of inflection is reported. In the case of 3GT homopolymer, the melting temperature is about 228° C. and Tg is about 50° C. The heat set temperature may be from about 85° C. to 190° C. or higher. Following the heat setting step, the film is cooled to a temperature below the heat set temperature. Such treatment will enable the resulting film to withstand heat equivalent to the heat set temperature used, with reduced or no shrinkage and in many cases improves toughness.

Heat shrinkable multilayer films of the invention are characterized by the ability to shrink to a size that is at least 25% less than their original dimension on initial exposure to a temperature of 85° C. for a period of one minute. Preferable films of the invention have the ability to shrink to a size that is at least 30% less than their original dimension on exposure to 85° C. Some examples of films of the invention particularly adapted to food packaging shrink film applications include multilayer films of the following structures. When the term tie is used below it means an adhesive layer. In the structures described below the term polyester blend means a 3GT polyester blended with another polyester composition.
Polyester blend/EVOH/polyethylene;
Polyester blend/tie/EVOH/tie/ethylene vinyl acetate;
Polyester blend/EVOH/ethylene alkyl acrylate;
Polyester blend/tie/EVOH/tie/ethylene alkyl methacrylate;
Polyester blend/tie/EVOH/tie/ ethylene alkyl methacrylate;
Polyester blend/tie/polyethylene or EMA/tie/polyester blend;
Polyester blend/tie/polyamide/tie/polyester blend; and
Polyethylene/tie/polyester blend/tie/polyethylene.

Films of the invention are useful for encasing and processing foodstuffs. Typically, the films are made into tubular casings, either by using blown film techniques to prepare a tubular form directly or by forming a flat sheet of the film into a tubular structure and fastening the edges of the sheet in a seam running the length of the tube. To facilitate the introduction of the foodstuff into the interior of the tubular casing, the casing optionally may be shirred prior to the introduction of the foodstuff. The term “shirred” means that the tubular casing is gathered into a multiplicity of rows parallel to the circumference of the tubing. The foodstuff is introduced into the interior of the optionally shirred tubular casing via the open end and the tube is stretched out to encase the foodstuff. One skilled in the art of packaging foodstuffs can readily introduce the foodstuff into the casing using well-established procedures.

Foodstuffs that can be processed using film of this invention include beef, pork, poultry (for example, chicken and turkey), seafood (for example, fish and mollusks) and cheese. Meat products include, but are not limited to sausages, lunchmeats, hams, turkey, hot dogs and sausages. Meat products can be whole-muscle, formulated into various meat slurries, formed into shapes, or ground. In the case of formed or ground meat, the meat can optionally be a mixture of material derived from more than one species. The foodstuff can be processed prior to its introduction into a casing of the invention and then further processed in the casing.

The heat shrinkable films of the invention are also particularly useful in other packaging applications and may be used as in packaging of, for example, primal beef cuts, boneless pork loins, marinated pork and beef cuts, smoked cheeses, soft cheeses and hard cheeses. The films may be formed into shrinkbags or other articles, including shrink lidding, shrink sleeves and shrink wraps. Shrink liddings are articles of film that can be sealed and shrunk onto trays containing food products. Shrink sleeves are shrinkable films that are first printed (either reverse printed or surface printed) and then shrunk around bottles, and are particularly useful for blow molded bottles that have sidewalls of various shapes. Shrink wraps are articles of films that can be completely shrunk around containers such as trays, without having to heat seal onto the flanges of the trays. This is particularly useful if the trays do not heat seal well or easily deform during heat sealing. Such shrinkwraps can further provide improved barrier properties, if the container contains perishable food products such as deli meats, cheeses, ground pork, ground poultry, smoked fish, etc. Such shrinkwraps can be further printed prior to the shrink operation to provide useful graphics for branding or consumer information.

A tubular biaxially oriented film as prepared above that has not been subjected to heat treatment may be processed into shrink bags by forming seals (for example, by heat-sealing or radio-frequency welding) across the tube surface and cutting the sealed tube into lengths, thereby providing tubes with one closed end and one open end. Materials to be packaged can be inserted into the tubes through the open end and then sealed to form filled shrink bags by sealing the open ends of the tubes. In some cases, the operations of forming the shrink bag, filling and sealing can be carried out consecutively and/or simultaneously using automated machinery.

In another embodiment, multilayer films of the invention can also be made into bags, such as vacuum bags, shrinkbags, and pouches. Such bags can be formed from tubular film by sealing and then cutting the film transversely. Alternatively, the tubular film may be slit into flat film, and then sealed transversely at the top and bottom to produce bags. Alternatively, flat film whether produced by tubular or cast processes may be made into bags by folding the film and then sealing and cutting along two exposed lengths. Other methods of making bags and pouches are known and can be also used for the films of this invention.

The invention is further illustrated by the specific embodiments disclosed in the following Examples.

### EXAMPLES

A series of blends of polyesters is prepared by pellet blending the polymeric components listed in Table I. Biaxially oriented multilayer films are prepared from each of the blends by the following process. A pellet blend sample is introduced to an extruder and extruded through a slot die at a temperature sufficiently high to form a molten extrudate. The molten extrudate is coated onto a film bilayer substrate having a layer of ethylene vinyl alcohol and another layer of ethylene methyl acrylate. The cooled multilayer structure thus formed is biaxially oriented using a tenterframe apparatus at a temperature of 50° C. The resultant biaxially oriented films are suitable for use as shrink labels if not heat set or as pouches if heat set at 130-150° C.

TABLE I

| Sample | Wt. % 3GT-1¹ | Wt. % 2GT-1² |
|---|---|---|
| 1 | 100 | 0 |
| 2 | 80 | 20 |
| 3 | 60 | 40 |
| 4 | 40 | 60 |
| 5 | 20 | 80 |
| 6 | 0 | 100 |

¹3GT-1: a poly(trimethylene terephthalate) composition available under the tradename Sorona ® from DuPont.
²2GT-1: a poly(ethylene terephthalate) composition available under the tradename Laser+ ® from DAK Americas, Chadds Ford, PA.

1. A process for preparing a heat shrinkable multilayer biaxially oriented film wherein at least one layer comprises a poly(trimethylene terephthalate) resin blend composition, the process comprising:
(a) extruding a polymer melt, the polymer melt comprising a blend of a poly(trimethylene terephthalate) resin and an additional polyester resin, through a die;
(b) allowing the extruded polymer melt to solidify on the surface of a substrate comprising at least one additional thermoplastic polymer layer to form a primary film having a degree of crystallinity required for subsequent processing while controlling the temperature and thickness of the primary film;
(c) simultaneously biaxially orienting the primary film at an orientation temperature in two mutually perpendicular directions in the plane of the primary film to form a biaxially oriented film; and
(d) cooling the biaxially oriented film to a temperature below the orientation temperature.

2. A process for preparing a dimensionally stable multilayer biaxially oriented film, at least one layer comprising a poly(trimethylene terephthalate) resin blend composition, the process comprising:
(a) extruding a polymer melt, the polymer melt comprising a blend of a poly(trimethylene terephthalate) resin and an additional polyester resin, through a die;
(b) allowing the extruded polymer melt to solidify on the surface of a substrate comprising at least one additional thermoplastic polymer layer to form a primary film having a degree of crystallinity required for subsequent processing while controlling the temperature and thickness of the primary film;
(c) simultaneously biaxially orienting the primary film in two mutually perpendicular directions in the plane of the primary film to form a biaxially oriented film;
(d) heat setting the biaxially oriented film at a heat set temperature; and
(e) cooling the biaxially oriented film to a temperature below that of the heat set temperature,
thereby obtaining a dimensionally stable biaxially oriented film.

3. A process of claim 1 wherein the primary film comprises an adhesive tie layer.

4. A process of claim 2 herein the primary film comprises an adhesive tie layer.

5. An article comprising a multilayer film prepared by the process of claim 1.

6. An article comprising a multilayer film prepared by the process of claim 2.

7. An article of claim 5 wherein the multilayer film comprises an adhesive tie layer.

8. An article of claim 6 wherein the multilayer film comprises an adhesive tie layer.

9. The article of claim 5 comprising a sausage casing.

10. The article of claim 5 comprising a shrinkbag.
